(19) United States
(12) Patent Application Publication
(10) Pub. No.: US 2023/0087408 A1
(43) Pub. Date: Mar. 23, 2023

(54) THERMOCOUPLE WITH BUILT-IN ERROR COMPENSATION

(71) Applicant: WATLOW ELECTRIC MANUFACTURING COMPANY, St. Louis, MO (US)

(72) Inventors: Don RECUPIDO, Crystal Lake, IL (US); Jacob LINDLEY, St. Louis, MO (US); Fernando DIAZ, Crystal Lake, IL (US); William MOY, St. Louis, MO (US)

(73) Assignee: WATLOW ELECTRIC MANUFACTURING COMPANY, St. Louis, MO (US)

(21) Appl. No.: 17/949,677

(22) Filed: Sep. 21, 2022

Related U.S. Application Data
(60) Provisional application No. 63/246,469, filed on Sep. 21, 2021.

(51) Int. Cl. G01K 7/02; G01K 7/16

(52) U.S. Cl. CPC G01K 7/021; G01K 7/16

(57) ABSTRACT

A temperature sensing system includes an outer casing, a thermocouple including a thermocouple junction, and a reference sensor. The thermocouple and the reference sensor are received within the outer casing. The reference sensor is disposed proximate an end of the thermocouple opposing the thermocouple junction and is configured to provide a reference temperature based on which a temperature measured by the thermocouple is determined.

### CROSS-REFERENCE TO RELATED APPLICATION

This application claims priority to and the benefit of U.S. patent application Ser. No. 63/246,469, filed on Sep. 21, 2021. The disclosure of the above application is incorporated herein by reference.

### FIELD

The present disclosure relates to temperature sensors, and more specifically to thermocouple assemblies with improved accuracy in temperature measurement.

### BACKGROUND

The statements in this section merely provide background information related to the present disclosure and may not constitute prior art.

A thermocouple typically includes a pair of conductors made of dissimilar materials that are joined at one end to form a thermocouple junction, or a “hot” junction. The thermocouple junction generates a temperature-dependent voltage in response to a temperature change due to Seebeck effect. By determining the voltage generated at the thermocouple junction, the temperature measured by the thermocouple junction can be determined.

To accurately determine the temperature measured by the thermocouple junction, the temperature of a controller, which is disposed at a cold end of the thermocouple, and which receives the voltage signals from the thermocouple must be known. The temperature of the “cold” end is used as a reference temperature based on which the temperature of the thermocouple junction can be determined.

Typically, the controller is disposed away from the thermocouple and a room temperature is used as the reference temperature. In some applications, extension wires that connect the thermocouple conductors to the controller are immersed in an ice bath such that the reference temperature is set to be 0° C.

In applications where precise temperature measurement is critical, extension wires that have the same compositions of the thermocouple conductors are used for connecting the thermocouple conductors to the controller such that the connection of the extension wires to the thermocouple conductors do not generate any temperature-dependent voltage to cause measurement errors. However, such extension wires are expensive and increase manufacturing costs.

In some applications where a connector with connecting pins is used, available connectors on the market do not use connecting pins having the same compositions of the thermocouple conductors. As a result, the connection between the connecting pins and the thermocouple conductors and the connection between the connecting pins and the lead wires cause generation of temperature-dependent voltage, undesirably affecting the temperature measurement by the thermocouple.

The above issues, among other issues, are addressed by the disclosure of the present application.

### SUMMARY

This section provides a general summary of the disclosure and is not a comprehensive disclosure of its full scope or all of its features.

In one form, the present disclosure provides a temperature sensing system that includes an outer casing, a thermocouple including a thermocouple junction, and a reference sensor. The thermocouple and the reference sensor are received within the outer casing. The reference sensor is disposed proximate an end of the thermocouple opposing the thermocouple junction and is configured to provide a reference temperature based on which a temperature measured by the thermocouple is determined.

The following includes variations of the temperature sensing system of the above paragraph, which may be implemented individually or in any combination.

In some forms, the thermocouple includes a first conductor and a second conductor made of dissimilar metals, the first and second conductors each have a proximal end and a distal end opposing the proximal end, the proximal ends of the first and second conductors are joined to form a thermocouple junction, and the reference sensor is disposed proximate the distal ends of the first and second conductors. In some forms, the temperature measured by the thermocouple is determined based on a voltage generated by the thermocouple junction and the reference temperature. In some forms, the temperature sensing system further includes a controller in electric communication with the thermocouple and the reference sensor, the controller configured to receive a first signal indicative of a voltage generated by the thermocouple junction and a second signal indicative of the reference temperature from the reference sensor. In some forms, the temperature sensing system further comprising extension wires disposed inside the outer casing and connected to the thermocouple and the reference sensor. In some forms, the thermocouple junction is connected to the reference sensor in parallel. In some forms, the first and second signals are transmitted to the controller via the same connection wires. In some forms, the temperature sensing system further comprising connection pins connected to the extension wires and exposed from the outer casing. In some forms, the outer casing includes a thermocouple housing for receiving the thermocouple and a connector housing connected to the thermocouple housing for receiving the reference sensor. In some forms, the thermocouple housing is a shower hose. In some forms, the reference sensor is a resistance temperature detector (RTD). In some forms, the outer casing is adapted to provide a uniform thermal profile about the reference sensor, and the outer casing has a wall having a predetermined thickness, a heat dissipating feature, a fluid medium, or a combination thereof to provide the uniform thermal profile.

In one form, the present disclosure provides a thermocouple assembly that includes a thermocouple, extension wires, a reference sensor, and an outer casing for receiving the thermocouple, the extension wires, and the reference sensor therein. The thermocouple includes a first conductor and a second conductor made of dissimilar metals and joined to form a thermocouple junction. The extension wires are connected to the first and second conductors. The reference sensor is connected to the extension wires.

The following includes variations of the thermocouple assembly of the above paragraph, which may be implemented individually or in any combination.

In some forms, the outer casing includes: a thermocouple housing for receiving the thermocouple therein, and a connector housing connected to the thermocouple housing for receiving the reference sensor therein. In some forms, the outer casing further comprises a fitting disposed between the thermocouple housing and the connector housing for mounting the outer casing to an adjacent component. In some forms, the thermocouple assembly further comprising a plurality of connection pins connected to the extension wires and exposed from the outer casing. In some forms, the reference sensor is embedded inside the outer casing. In some forms, the reference sensor is configured to generate a signal indicative of a temperature of a reference junction of the thermocouple. In some forms, the extension wires are configured to transmit a first signal indicative of a voltage generated by the thermocouple junction and a second signal indicative of a temperature measured by the reference sensor to an external device.

In one form, the present disclosure provides a temperature sensing system that includes a thermocouple assembly and a controller. The thermocouple assembly includes a thermocouple, a resistance temperature detector (RTD), and an outer casing for receiving the thermocouple and the RTD therein. The controller is in electrical communication with the thermocouple and the reference sensor for receiving a first signal indicative of a voltage generated by the thermocouple, and for receiving a second signal indicative of a reference temperature measured by the RTD. The controller determines a temperature measured by the thermocouple based on the first signal and the second signal.

The following includes variations of the thermocouple assembly of the above paragraph, which may be implemented individually or in any combination.

In some forms, the thermocouple includes a first conductor and a second conductor made of dissimilar metals and joined to form a thermocouple junction, the extension wires are connected to the first and second conductors, and the RTD is connected to the extension wires and disposed proximate to where the extension wires are connected to the first and second conductors.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a temperature sensing system constructed in accordance with the teachings of the present disclosure;

FIG. 2 is a schematic view of an electric circuit including a thermocouple, a reference sensor, and extension wires disposed inside the temperature sensing system and constructed in accordance with the teachings of the present disclosure;

FIG. 3 is a schematic view of a variant of an electric circuit including a thermocouple, a reference sensor, and extension wires disposed inside the temperature sensing system and constructed in accordance with the teachings of the present disclosure;

FIG. 4 is a schematic view of another variant of an electric circuit including a thermocouple, a reference sensor, and extension wires disposed inside the temperature sensing system and constructed in accordance with the teachings of the present disclosure;

FIGS. 5A and 5B is a schematic view and an exploded view of an outer casing having heat dissipating features, respectively, in accordance with the teachings of the present disclosure; and

FIGS. 6A and 6B is a schematic view and an exploded view of an outer casing having constant temperature body, respectively, in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

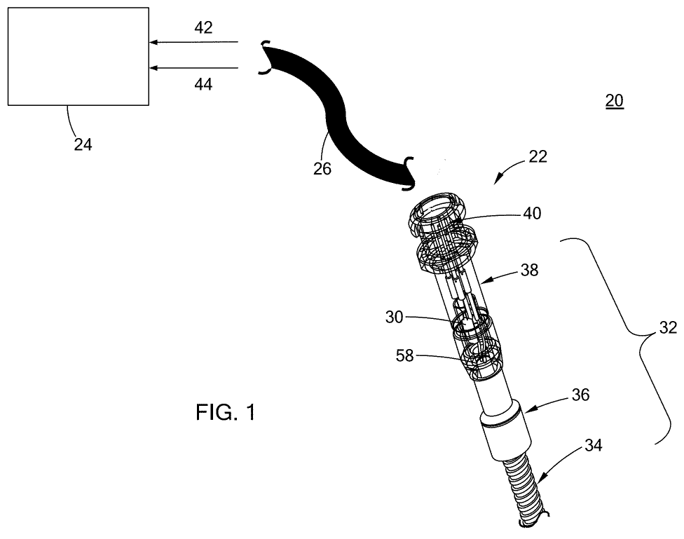

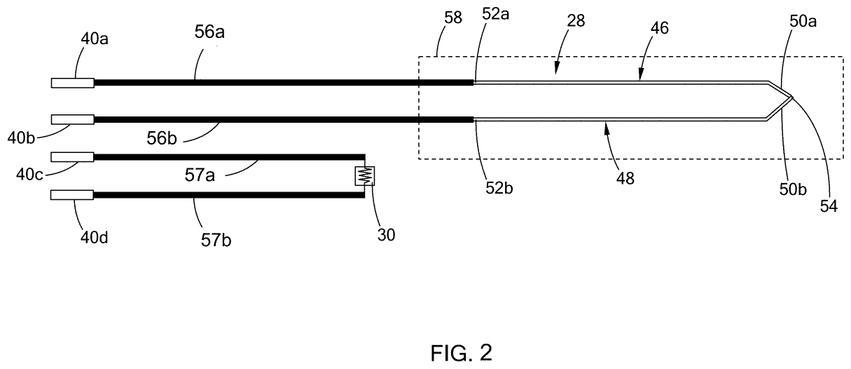

Referring to FIG. 1, a temperature sensing system 20 constructed in accordance with the teachings of the present disclosure includes a temperature sensor assembly 22 and a controller 24 in electrical connection with the temperature sensor assembly 22 via a cable 26. The temperature sensor assembly 22 may be a thermocouple assembly including a thermocouple 28 (shown in FIG. 2), a reference sensor 30, and an outer casing 32 for receiving the thermocouple 28 and the reference sensor 30 therein. The outer casing 32 includes a thermocouple housing 34 for receiving the thermocouple 28 therein, a fitting 36 connected to the thermocouple housing 34, and a connector housing 38 for receiving the reference sensor 30 therein. The fitting 36 is configured to secure the temperature sensor assembly 22 to an adjacent component. For example, the fitting 36 may be fitted into an opening of the adjacent component such that the thermocouple housing 34 is disposed inside a chamber (not shown) whose temperature is to be measured, and such that the connector housing 38 is disposed outside the chamber and is not exposed to the harsh conditions inside the chamber. In one form, the thermocouple housing 34 is a flexible and bendable hose (e.g., a shower hose) to allow for easy mounting of the temperature sensor assembly 22 to an apparatus.

The temperature sensor assembly 22 further includes a plurality of connection pins 40 disposed in the connector housing 38 and exposed from the outer casing 32 for connection to lead wires (not shown) inside the cable 26. Signals from the temperature sensor assembly 22 are transmitted via the cable 26 to the controller 24 in which the signals are processed and temperature measured by the thermocouple 28 is determined. The signals include a first signal 42 indicative of a temperature-dependent voltage generated by the thermocouple 28 and a second signal 44 indicative of a reference temperature measured by the reference sensor 30.

Referring to FIG. 2, in one form, the thermocouple 28 includes a first conductor 46 and a second conductor 48 made of dissimilar metals. The first and second conductors 46, 48 each have a proximal end 50a, 50b, respectively and a distal end 52a, 52b, respectively opposing the proximal end 50a, 50b. The proximal ends 50a, 50b of the first and second conductors 46, 48 are joined to form a thermocouple junction 54. In one form, one of the first and second conductors 46, 48 may be made of Chromel, and the other one of the first and second conductors 46, 48 may be made of Alumel. While specific materials are provided, other suitable materials may be employed for the first and second conductors 46, 48. The temperature sensor assembly 22 further includes extension wires 56a, 56b for connecting the first and second conductors 46, 48, respectively to the connection pins 40a, 40b, respectively which, in turn, connects the thermocouple 28 to the cable 26 or directly to an external device.

In one form, the reference sensor 30 is disposed proximate the distal ends 52a, 52b of the first and second conductors 46 and 48. In the example application of FIG. 2, the reference sensor 30 is connected to extension wires 57a, 57b, which are connected to connection pins 40c, 40d. The reference sensor 30 is connected to the controller 24 via connection pins 40c, 40d to provide the second signal 44. The second signal 44 is a signal indicative of a temperature of the distal ends 52a, 52b (i.e., the cold junction, or the reference junction) of the first and second conductors 46, 48 and generated by the reference sensor 30. Accordingly, the second signal 44 is provided to the controller 24 via at least, the extension wires 57a, 57b and connection pins 40c, 40d. It should be readily understood that the connection pins 40a, 40b, 40c and 40d are among the plurality of connection pins 40.

With continuing reference to FIGS. 1 and 2, the first and second conductors 46, 48 of the thermocouple 28 and the distal ends 52a, 52b of the first and second conductors 46, 48 to which the extension wires 56a, 56b are joined, may be embedded in a mineral insulation cable 58, which provides electrical insulation for the thermocouple 28 and the extension wires 56a, 56b. The mineral insulation cable 58 is surrounded by the thermocouple housing 34. A portion of the extension wires 56a, 56b is exposed from the mineral insulation cable 58 to allow for connection of the extension wires 56a, 56b to the connection pins 40a, 40b.

In one form, the first signal 42, which is indicative of the voltage output of the thermocouple junction 54, is provided to the controller 24 via the connection pins 40a, 40b. Specifically, the thermocouple 28 is connected to the controller 24 via at least the connection pins 40a, 40b and the extension wires 56a, 56b, which are connected to the distal ends 52a, 52b of the first and second conductors 46, 48. In addition, the second signal 44, which is indicative of the reference temperature, is provided to the controller 24 via, at least, the connection pins 40c, 40d and the extension wires 57a, 57b, which are connected to reference sensor 30.

The reference sensor 30 is a sensor for generating a signal indicative of a temperature. For example, in one form, the reference sensor 30 is a resistance temperature detector (RTD) and thus, the second signal 44 may be a voltage output across the RTD, based on which the temperature of the RTD, and thus the temperature of the distal ends 52a, 52b of the first and second conductors 46, 48 proximate the RTD, is determined. The controller 24 determines a reference temperature at or near the distal ends 52a, 52b based on the second signal 44 and uses both the reference temperature and the first signal 42 to determine the temperature of the thermocouple junction 54. It is understood that any device that can measure the temperature of the distal ends 52a, 52b of the first and second conductors 46, 48 can be used as the reference sensor 30 without departing from the scope of the present disclosure.

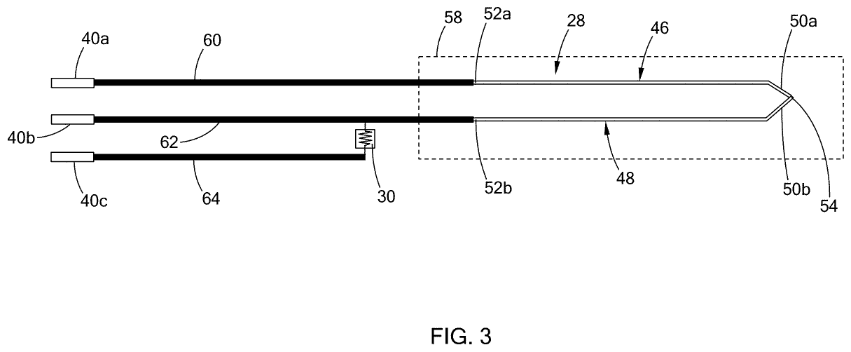

Referring to FIG. 3, alternatively, instead of using two pairs of extension wires 56a, 56b, 57c, and 57d that transmit the first and second signals 42, 44, three extension wires 60, 62, 64 may be used. In this variation, the plurality of connection pins 40 includes at least three connections pins 40a, 40b, and 40c. As shown, a first extension wire 60 and a second extension wire 62 are connected to the first and second conductors 46, 48, respectively and the controller 24 via the connecting pins 40a, 40b. The reference sensor 30 is connected between the second extension wire 62 and a third extension wire 64 and connected to the controller 24, via the connecting pins 40b, 40c, respectively. The first and second extension wires 60, 62 transmit the first signal 42 to the controller 24, via the connection pins 40a, 40b, whereas the second and third extension wires 62, 64 transmit the second signal 44 to the controller 24, via connection pins 40b, 40c.

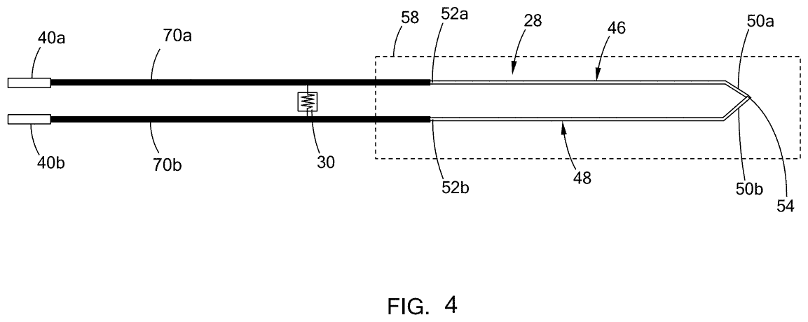

Referring to FIG. 4, in another variation, a pair of connection pins 40a, 40b and a pair of two extension wires 70a, 70b are used to connect the thermocouple 28 and the reference sensor 30 to the controller 24 to provide the first and second signals 42, 44. More specifically, the first and second conductors 46, 48 are connected to the extension wires 70a, 70b. With portions of the extension wires 70a, 70b exposed from the mineral insulation cable 58, the wires 70a, 70b are connected to the reference sensor 30. Accordingly, the reference sensor 30 and the thermocouple junction 54 are connected in parallel to form a parallel circuit.

The first signal 42 and the second signal 44 may be transmitted to the controller 24 via the same extension wires 70a, 70b at different times. For example, the first signal provided by the thermocouple junction 54 is a signal in the millivolt (mV) range, whereas the second signal is in the voltage range (0.5-5V). Specifically, for the second signal from the reference sensor 30, a known voltage is applied to the measure an electric current (i.e., a second signal) within a known range (e.g., 1-5 mA), which is employed to determine resistance and thus, temperature. Alternatively, in another variation, the controller 24 is configured to receive an output signal that is indicative of a combination of the first signal and the second signal. The controller 24 is configured to determine electrical characteristics of the output signal that is indicative of the first signal and indicative of the second signal (e.g., amount of voltage and/or current associated with the first signal and the second signal). For example, the controller 24 may include signal processing circuitry and/or a series of algorithms defined during experimental testing to determine the first signal 42 and the second signal 44 from the output signal, which are then used to determine temperature as provided above.

In the various examples provided, the extension wires may be made of copper.

In the present disclosure, the reference sensor 30 is built in and embedded inside the outer casing 32 of the temperature sensor assembly 22 to measure the temperature of the distal ends, i.e., the “cold ends” or the reference junction of the thermocouple 28. Alternatively, the temperature sensor assembly 22 of the present disclosure may also employ a reference sensor that is discrete and disposed inside the outer casing 32, and therefore, the reference sensor does not have to formed or built in the casing 32. The temperature sensor assembly 22 transmits both the first signal 42 indicative of the temperature-dependent voltage generated by the thermocouple junction 54 and the second signal 44 indicative of a temperature of the distal ends of the thermocouple to the controller 24. Therefore, the determination of the temperature measured by the thermocouple 28 does not depend on the materials of the lead wires that connect the thermocouple 28 to the controller 24 and the location of the controller 24. As such, less expensive lead wires and available connectors can be used to facilitate connection of the temperature sensor assembly 22 to a controller 24 without compromising the accurate termination of the temperature measured by the thermocouple 28.

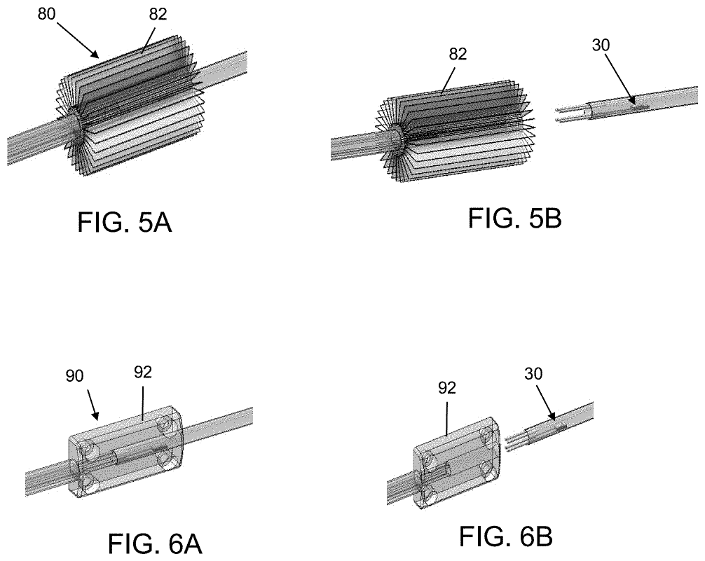

In one form, it may be beneficial to improve the accuracy and performance of the reference sensor 30 by stabilizing the temperature of the environment about the reference sensor 30. In an example application, the outer casing 32 has a predetermined thickness to provide a uniform thermal profile about the reference sensor 30, thereby causing a thermal flywheel effect to maintain a near-constant temperature in the environment of the reference sensor 30. In one form, the thickness of the outer casing 32 may be determined via experimentation, computer aided design software, and/or other known tools. In another variation, the outer casing 32 includes one or more heat dissipating features, such as one or more fins or flattened appendage extensions extending from the casing and adapted to dissipate heat away and stabilize the temperature about the reference sensor. For example, referring to FIGS. 5A and 5B, an outer casing 80 includes heat dissipating features 82 that are provided as fins radially extending from a center axis of the casing 80. Referring to FIGS. 6A and 6B, in another variation, an outer casing 90 includes a constant temperature body 92 (e.g., a heat sink) adapted to passively transfer heat between the environment of the reference sensor and a fluid medium (e.g., air or a liquid coolant) to stabilize the temperature of the environment about the reference sensor 30. In yet another example, the outer casing 32 is at least partially or completely enclosed and maintained by a fluid medium (e.g., one or more water cooling tubes) to stabilize the environment of the reference sensor 30. It should be noted that one or more of the above-mentioned example applications of the outer casing 32 and the reference sensor 30 used individually or in combination with one another are intended to be within the scope of the disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A temperature sensing system comprising:
an outer casing;
a thermocouple including a thermocouple junction and received within the outer casing; and
a reference sensor received within the outer casing and disposed proximate an end of the thermocouple opposing the thermocouple junction,
wherein the reference sensor is configured to provide a reference temperature based on which a temperature measured by the thermocouple is determined.

2. The temperature sensing system according to claim 1, wherein:
the thermocouple includes a first conductor and a second conductor made of dissimilar metals,
the first and second conductors each have a proximal end and a distal end opposing the proximal end,
the proximal ends of the first and second conductors are joined to form the thermocouple junction, and
the reference sensor is disposed proximate the distal ends of the first and second conductors.

3. The temperature sensing system according to claim 1, wherein the temperature measured by the thermocouple is determined based on a voltage generated by the thermocouple junction and the reference temperature.

4. The temperature sensing system according to claim 1, further comprising a controller in electric communication with the thermocouple and the reference sensor, the controller configured to receive a first signal indicative of a voltage generated by the thermocouple junction and a second signal indicative of the reference temperature from the reference sensor.

5. The temperature sensing system according to claim 4 further comprising extension wires disposed inside the outer casing and connected to the thermocouple and the reference sensor.

6. The temperature sensing system according to claim 5, wherein the thermocouple junction is connected to the reference sensor in parallel.

7. The temperature sensing system according to claim 6, wherein the first and second signals are transmitted to the controller via the same connection wires.

8. The temperature sensing system according to claim 5 further comprising connection pins connected to the extension wires and exposed from the outer casing.

9. The temperature sensing system according to claim 1, wherein the outer casing includes a thermocouple housing for receiving the thermocouple and a connector housing connected to the thermocouple housing for receiving the reference sensor.

10. The temperature sensing system according to claim 9, wherein the thermocouple housing is a shower hose.

11. The temperature sensing system according to claim 1, wherein the reference sensor is a resistance temperature detector (RTD).

12. A thermocouple assembly comprising:
a thermocouple including a first conductor and a second conductor made of dissimilar metals and joined to form a thermocouple junction;
extension wires connected to the first and second conductors;
a reference sensor connected to the extension wires; and
an outer casing for receiving the thermocouple, the extension wires, and the reference sensor therein.

13. The thermocouple assembly according to claim 12, wherein the outer casing includes:
a thermocouple housing for receiving the thermocouple therein, and
a connector housing connected to the thermocouple housing for receiving the reference sensor therein.

14. The thermocouple assembly according to claim 13, wherein the outer casing further comprises a fitting disposed between the thermocouple housing and the connector housing for mounting the outer casing to an adjacent component.

15. The thermocouple assembly according to claim 12 further comprising a plurality of connection pins connected to the extension wires and exposed from the outer casing.

16. The thermocouple assembly according to claim 12, wherein the reference sensor is embedded inside the outer casing.

17. The thermocouple assembly according to claim 12, wherein the reference sensor is configured to generate a signal indicative of a temperature of a reference junction of the thermocouple.

18. The thermocouple assembly according to claim 12, wherein the extension wires are configured to transmit a first signal indicative of a voltage generated by the thermocouple junction and a second signal indicative of a temperature measured by the reference sensor to an external device.

19. The thermocouple assembly according to claim 12, wherein the outer casing is adapted to provide a uniform thermal profile about the reference sensor.

20. The thermocouple assembly according to claim 19, wherein the outer casing has a wall having a predetermined thickness, a heat dissipating feature, a fluid medium, or a combination thereof to provide the uniform thermal profile.

21. A temperature sensing system comprising:
a thermocouple assembly comprising a thermocouple, a resistance temperature detector (RTD), and an outer casing for receiving the thermocouple and the RTD therein; and
a controller in electrical communication with the thermocouple and the RTD for receiving a first signal indicative of voltage generated by the thermocouple, and for receiving a second signal indicative of a reference temperature measured by the RTD,
wherein the controller is configured to determine a temperature measured by the thermocouple based on the first signal and the second signal.

22. The temperature sensing system according to claim 21 further comprising extension wires, wherein:
the thermocouple includes a first conductor and a second conductor made of dissimilar metals and joined to form a thermocouple junction,
the extension wires are connected to the first and second conductors, and
the RTD is connected to the extension wires and disposed proximate to where the extension wires are connected to the first and second conductors.
